(19) United States
(12) Patent Application Publication
(10) Pub. No.: US 2024/0279942 A1
(43) Pub. Date: Aug. 22, 2024

(54) A CLEANING APPARATUS AND CLEANING SYSTEM

(71) Applicant: SUMMIT BUILDING WASH TECHNOLOGIES LIMITED, Lower Hutt (NZ)

(72) Inventors: Raymond TOMLINSON, Lower Hutt (NZ); Samuel CLAYTON, Lower Hutt (NZ)

(73) Assignee: SUMMIT BUILDING WASH TECHNOLOGIES LIMITED, Lower Hutt (NZ)

(21) Appl. No.: 18/569,127

(22) PCT Filed: Jun. 8, 2022
(86) PCT No.: PCT/NZ2022/050069

§ 371 Date: Dec. 11, 2023

(30) Foreign Application Priority Data
Jun. 9, 2021 (NZ) 777044
Nov. 8, 2021 (NZ) 782131

(51) Int. Cl. E04G 23/00; A47L 1/02; A47L 11/38; A47L 11/40; B66C 23/20

(52) U.S. Cl. CPC E04G 23/002; A47L 1/02; A47L 11/38; A47L 11/4005; A47L 11/4041; A47L 11/4072; A47L 11/4088; B66C 23/205

(57) ABSTRACT

An unmanned cleaning apparatus for cleaning structures such as buildings, more specifically windows on buildings includes a carriage, a cleaning element rotatably mounted on the carriage, at least a pair of support arms, at least a pair of electric ducted fans, a motor that in use is operable remotely to rotate the cleaning element about its horizontal axis across the surface to be cleaned, and a spray boom that is mounted on the carriage. A cleaning system includes the unmanned cleaning apparatus as described and a portable winching member.

The present disclosure relates to a cleaning apparatus for cleaning structures such as buildings, more specifically windows on buildings. In particular, the cleaning apparatus is configured for stabilisation against the structure whilst under operation. The present invention also relates to a cleaning system that incorporates a cleaning apparatus as herein described.

### BACKGROUND

Building structures, particularly tall urban buildings and specifically their windows, are typically difficult and time consuming to wash. Often window washers tie a climbing rope to the roof anchors of a building and throw the rope over the side of the building. Then they attach a climber's harness to themselves and effectively abseil down the building surface with a water/soap bucket cleaning the windows as they drop down the building structure.

The washing of buildings has proven to be quite dangerous, especially with respect to tall buildings in windy environments.

It is therefore an object to provide a mobile building washing apparatus that enables the cleaning of relatively flat surfaces, and especially elevated and/or sloped and/or vertical surfaces without the use of elevated/suspended personnel positioned at the specific site of cleaning, or to at least provide the public with a useful choice.

### SUMMARY

In a first aspect there is provided an unmanned cleaning apparatus suitable for cleaning a surface of a structure comprising:
a carriage adapted to be moved in upward and downward directions relative to the surface of a structure,
a cleaning element rotatably mounted on the carriage that in use rotates about a substantially horizontal axis, the cleaning element being configured to contact the surface,
at least a pair of support members mounted on the carriage to support the apparatus against the surface,
at least a pair of electric ducted fans, with one fan of each pair positioned at each end of the carriage and together the pair of fans, when in use, provide thrust to the carriage in a direction toward the surface being cleaned to stabilise the apparatus against the surface being cleaned;
a motor that in use is operable remotely to rotate the cleaning element about its horizontal axis across the surface being cleaned; and
a spray boom that is mounted on the carriage providing a plurality of spaced apart spray nozzles that in use spray water towards the cleaning element and the surface of the structure being cleaned.

In one embodiment, the apparatus includes at least one suspension member positioned proximate the top side of the carriage, which suspension member in use is connected to a winch line, which line, in use connects the apparatus to a winch that moves the carriage in an upward or downward direction as required.

In one embodiment the support member is a pair of wheels mounted on the carriage. In a preferred embodiment the support member comprises two pairs of wheels, each wheel being mounted proximate each corner of the carriage.

In one embodiment each wheel of the one or more pairs of wheels is mounted on an adjustable depth track that is configured to allow the forward and aft movement of each wheel relative to the cleaning element.

In one embodiment two pairs of electric ducted fans are provided with one fan of each pair positioned at each end of the carriage, each fan at each end of the carriage being in a spaced apart arrangement about the horizontal axis of the cleaning element.

In one embodiment the electric ducted fans are battery powered and operable independently of any external power source.

In one embodiment the cleaning element is a rotatable brush.

In one embodiment the pair of electric ducted fans together provide a combined thrust of at least 5% the weight of the cleaning apparatus, more preferably at least 10% the weight of the cleaning apparatus.

In one embodiment the unmanned cleaning apparatus includes a battery powered motor that drives the cleaning element independently of any external power source.

In another aspect, there is provided a cleaning system comprising a cleaning apparatus as defined above and a portable winching member that in use is configured to winch the cleaning apparatus up and down a surface being cleaned, the winch member in use being positioned on a surface above the surface being cleaned by the cleaning apparatus.

In one embodiment the portable winching member is connected to roof rigging or a roof mounted lifting device above the surface being cleaned by the cleaning apparatus.

In an alternative embodiment the winching member is included on the cleaning apparatus.

In one embodiment the cleaning apparatus further includes a portable winching member that in use is configured to winch the cleaning apparatus up and down a surface being cleaned, the winch member in use being positioned on a surface above the surface being cleaned by the cleaning apparatus.

In another aspect there is provided an unmanned cleaning apparatus suitable for cleaning a surface of a structure comprising:
a carriage adapted to be moved in upward and downward directions relative to the surface of a structure,
a cleaning element rotatably mounted on the carriage that in use rotates about a substantially horizontal axis, the cleaning element being configured to contact the surface, at least a pair of support members mounted on the carriage to support the apparatus against the surface,
at least a pair of lateral members configured and adapted such to support the lateral movement of the carriage across the structure surface when in use,
a motor that in use is operable remotely to rotate the cleaning element about its horizontal axis across the surface being cleaned; and
a spray boom that is mounted on the carriage providing a plurality of spaced apart spray nozzles that in use spray water towards the cleaning element and the surface of the structure being cleaned.

In one embodiment the at least pair of lateral members comprise pivoting arms that extend outwardly from the carriage. Preferably, each arm at its distal end includes an auxiliary movement member.

In one embodiment the apparatus comprises at least two pairs of lateral members.

In one embodiment the apparatus further includes at least a pair of electric ducted fans, with one fan of each pair positioned at each end of the carriage and together the pair of fans provide thrust to the carriage in a direction toward the surface being cleaned to stabilise the apparatus against the surface being cleaned when in use. Preferably, two pairs of electric ducted fans are provided with one fan of each pair positioned at each end of the carriage, each fan at each end of the carriage being in a spaced apart arrangement about the horizontal axis of the cleaning element.

In one embodiment the electric ducted fans are battery powered and operable independently of any external power source.

In one embodiment the pair of electric ducted fans together provide a combined thrust of at least 5% the weight of the cleaning apparatus, more preferably at least 10% the weight of the cleaning apparatus.

In one embodiment the unmanned cleaning apparatus includes a battery powered motor that drives the cleaning element independently of any external power source.

In one embodiment the unmanned cleaning apparatus includes a battery powered motor that drives the cleaning element independently of any external power source.

In one embodiment the cleaning element is a rotatable brush.

In one embodiment the apparatus further includes a winching member that is mounted to the carriage to facilitate the upwards and downwards movement of the carriage relative to the surface of the structure when in use.

Further aspects and embodiments will become apparent with reference to the following figures and description. The embodiments provided herein are provided for the purpose of illustrating specific embodiments and aspects of the invention and are not intended to limit the invention in any way. Persons of ordinary skill can utilise the disclosures and teachings herein to produce other embodiments, aspects, and variations without undue experimentation. All such embodiments, aspects, and variations are considered to be part of this invention.

### BRIEF DESCRIPTION OF THE FIGURES

The cleaning apparatus is now described, by way of a non-limiting example, with reference to the accompanying figures, in which:

FIG. 1 shows a schematic front perspective view of a cleaning apparatus.

FIG. 2 shows a front view of the cleaning apparatus.

FIG. 3 shows a left side view of the cleaning apparatus.

FIG. 4 shows a right side view of the cleaning apparatus.

FIG. 5 shows a rear view of the cleaning apparatus.

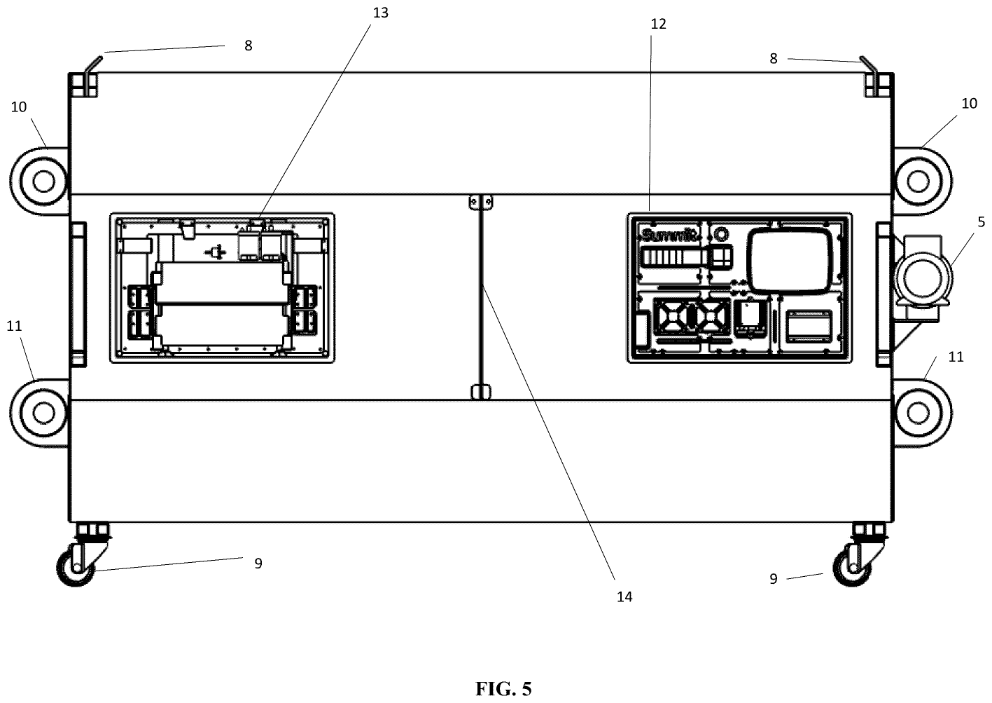

FIG. 6 shows a schematic front perspective front view of the stripped-down carriage of the cleaning apparatus.

FIG. 7 shows a left side view of the stripped-down carriage of the cleaning apparatus.

FIG. 8 shows a right side view of the stripped-down carriage of the cleaning apparatus.

FIG. 9 shows a rear view of the stripped-down carriage of the cleaning apparatus.

FIG. 10 shows a rear perspective photo of the cleaning apparatus connected to a water supply source.

FIG. 11 shows a front side perspective photo of the cleaning apparatus operating while connected to a water supply source.

FIG. 12 shows a side view photo of the cleaning apparatus in position to be suspended from a ground winch system against an upright surface.

FIG. 13 shows a top perspective view of a mobile rigging device to be used with a cleaning apparatus of the present invention.

FIG. 14 shows a side view of the mobile rigging device shown in FIG. 13.

FIG. 15. shows a left side view of another embodiment of a cleaning apparatus wherein the lateral members are extended outwards.

FIG. 16. shows a schematic front view of the embodiment.

FIG. 17. shows a left side view of the embodiment wherein the lateral members are retracted inwards.

FIG. 18. shows a top view of the embodiment wherein the lateral members are partially extended outwards.

FIG. 19. shows a left side view of the embodiment wherein the access port is open.

FIG. 20. shows a front view of the embodiment.

FIG. 21. shows a rear view of the embodiment.

In reviewing the figures, and especially the schematics, the proportions shown in the figures, and the specific position of elements is not intended to be limiting with respect to the structures disclosed or the scope of claims appended hereto, but rather are intended to be instructive of a generic concept.

### DETAILED DESCRIPTION OF THE INVENTION

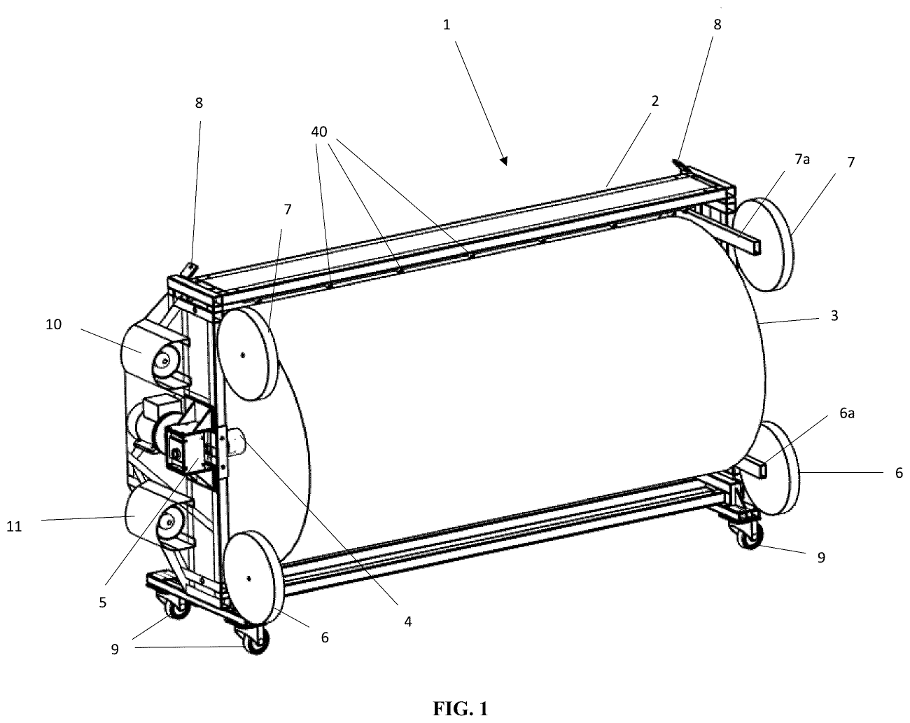

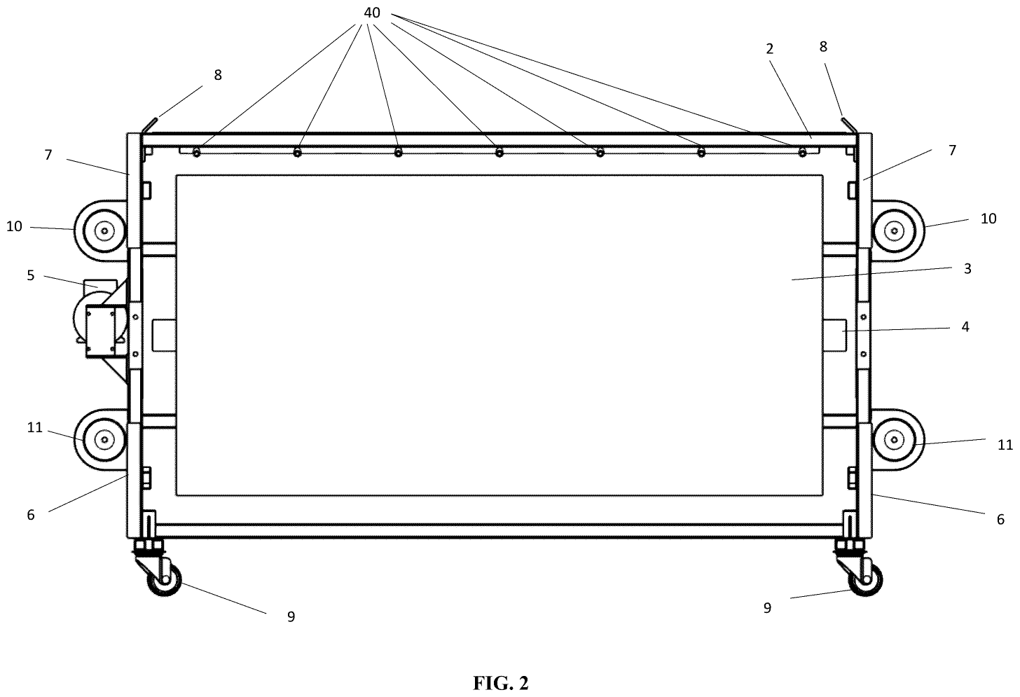

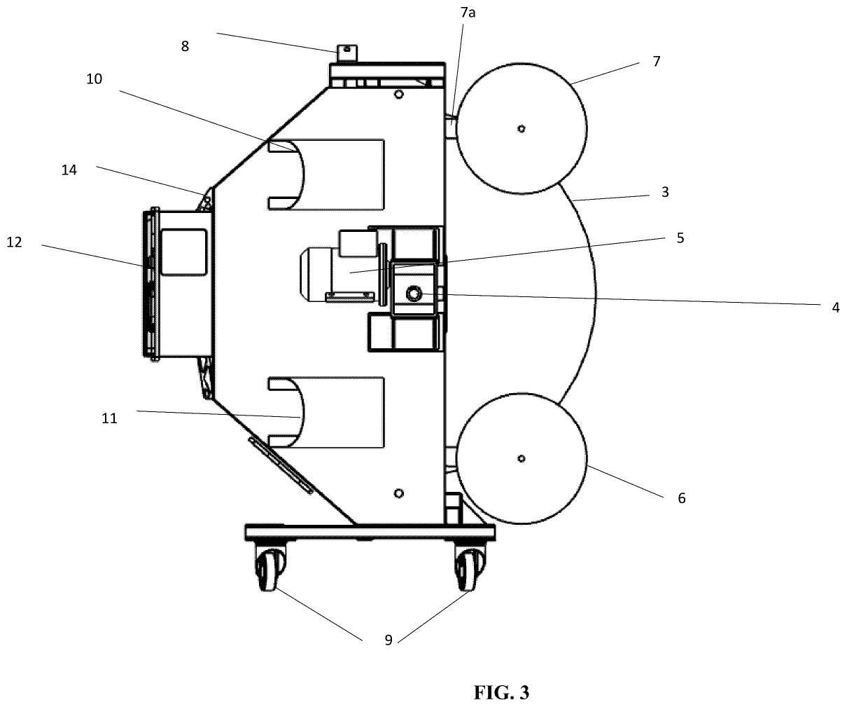

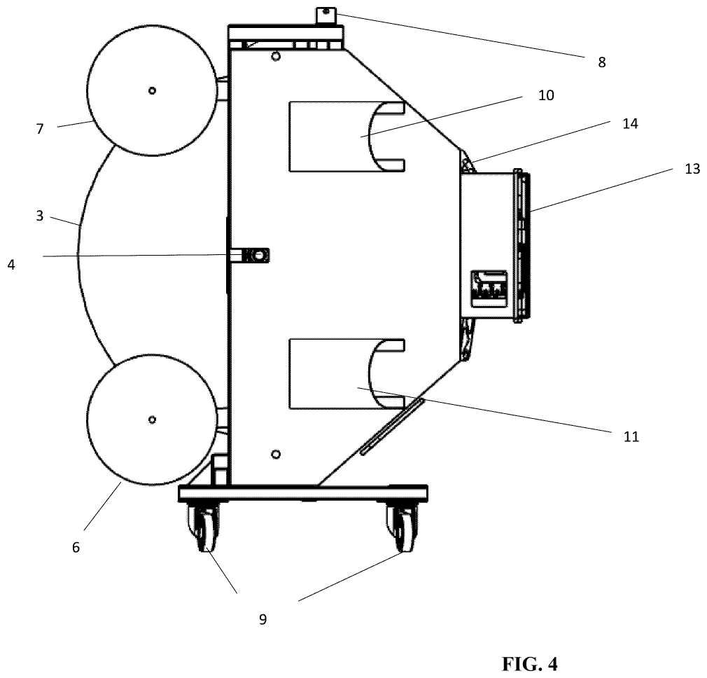

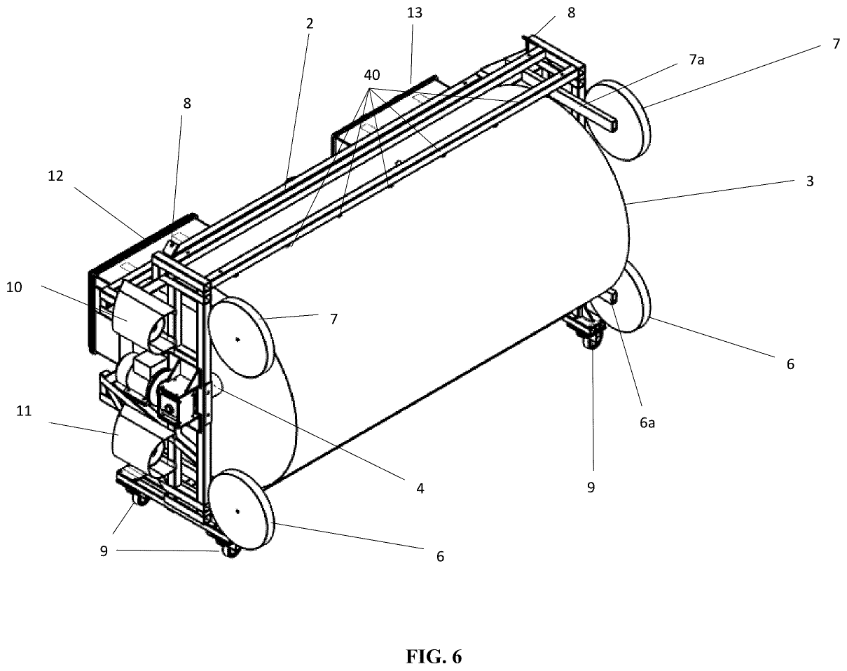

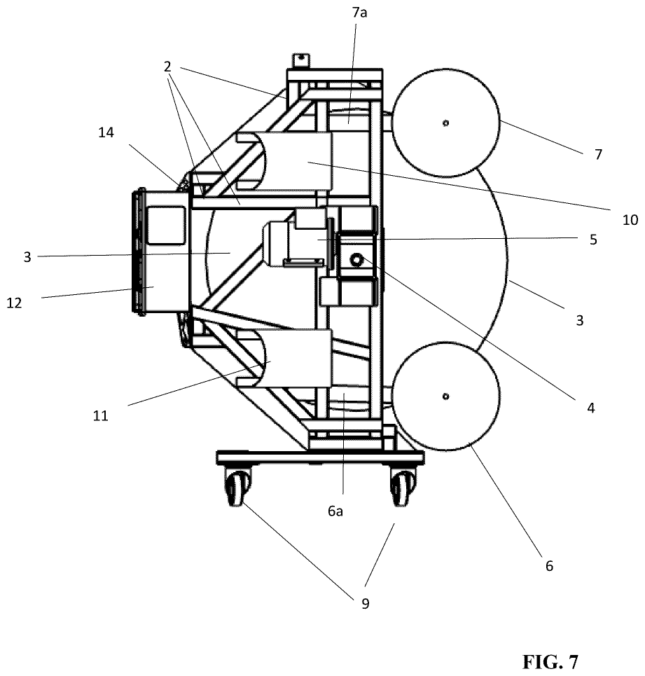

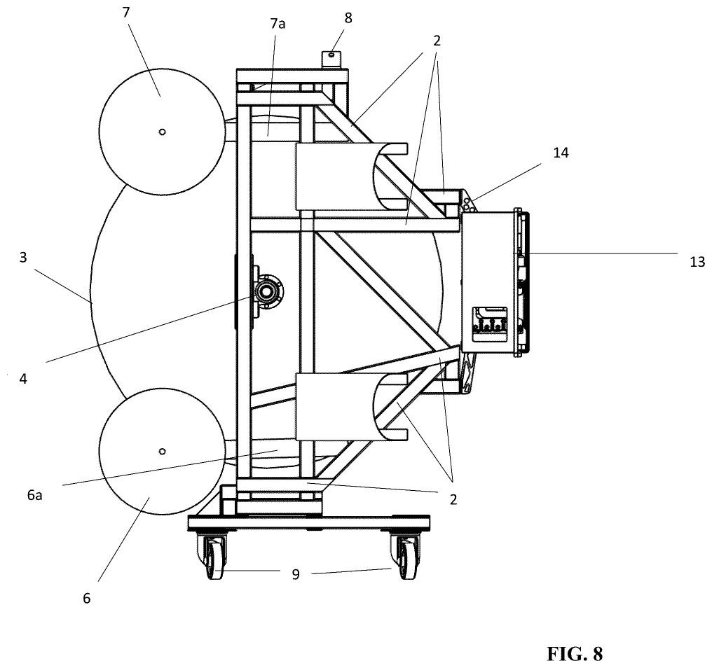

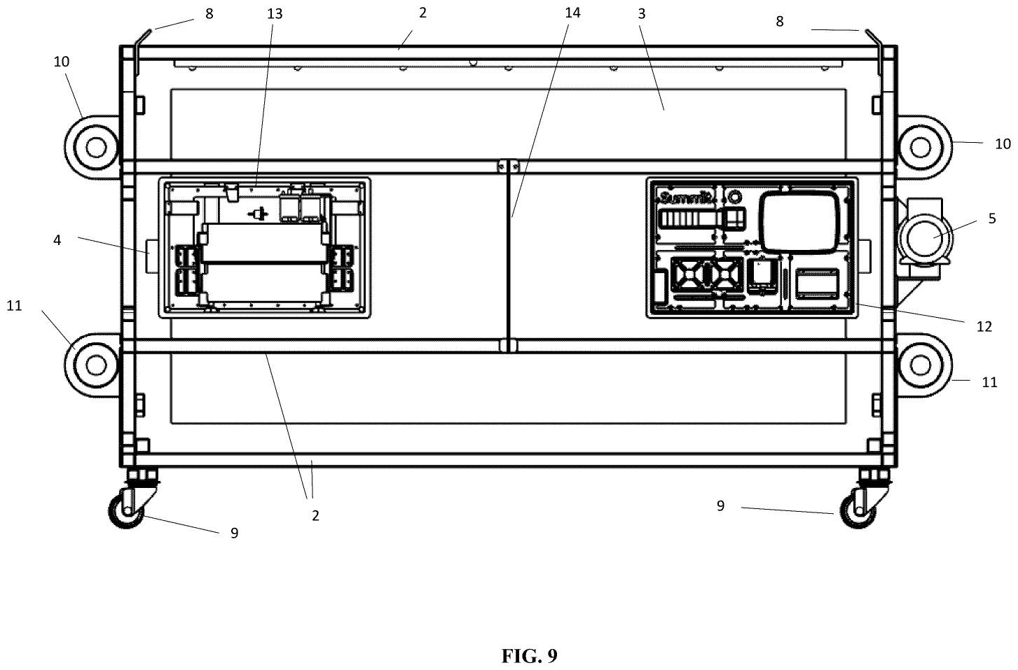

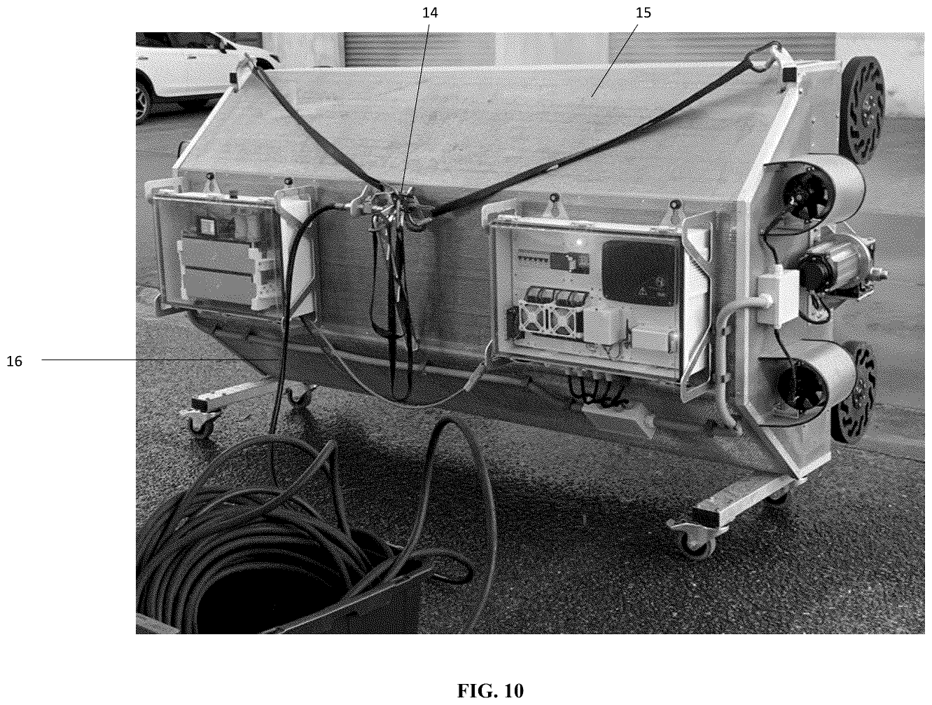

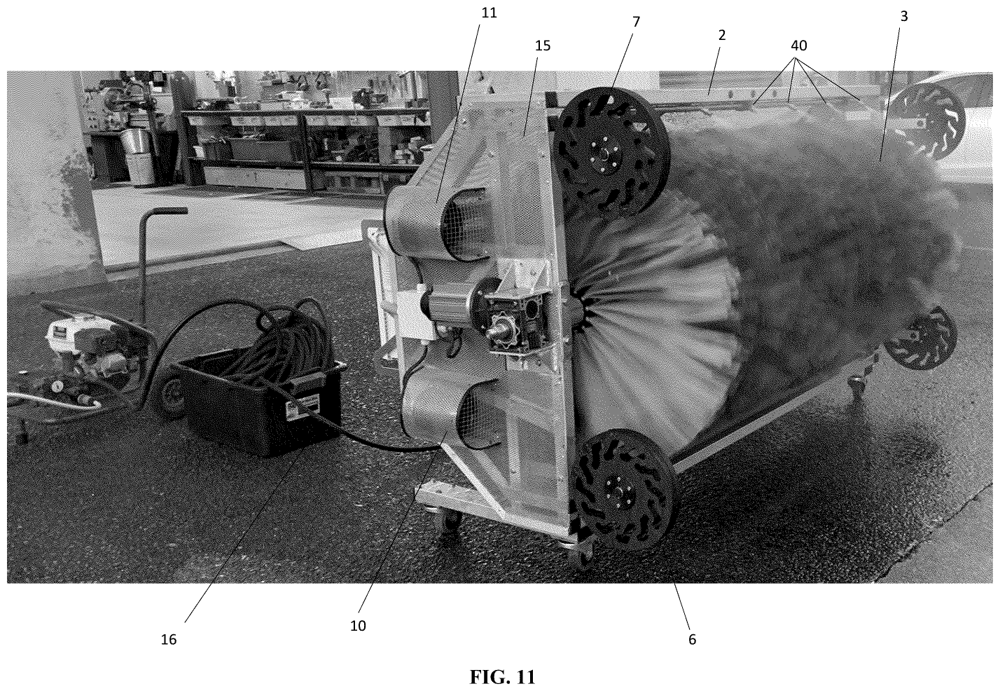

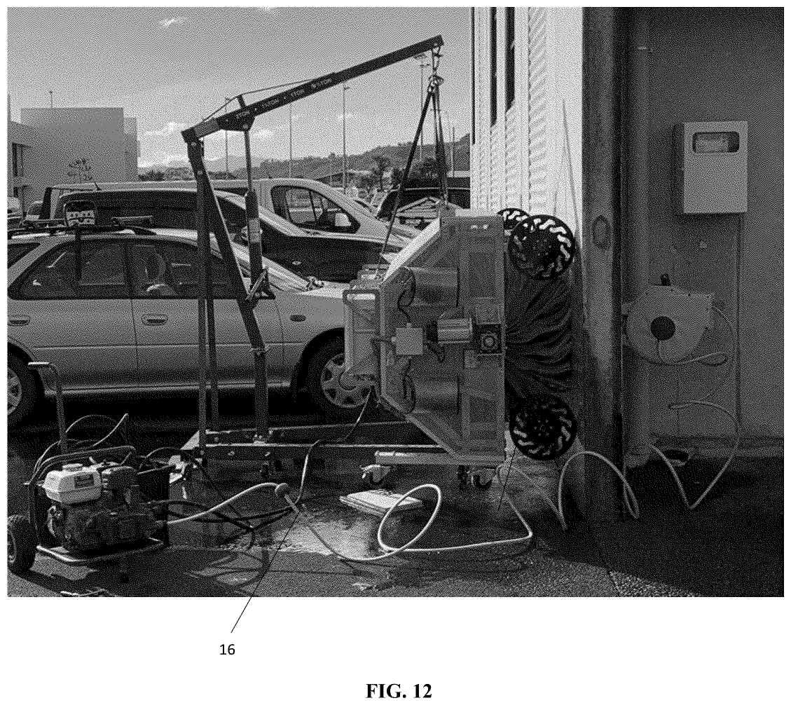

The present invention provides a moveable and portable cleaning apparatus that enables the cleaning of relatively flat surfaces, and especially elevated and/or sloped and/or vertical surfaces without the use of elevated or suspended personnel at the specific site of cleaning. With reference to FIGS. 1 and 2 the cleaning apparatus 1 ordinarily comprises a frame or carriage 2 carrying at least a cleaning element 3, which may consist of a number of members having outer end portions that contact a surface area for cleaning or “bristles” or flexible brushing members, which cleaning element in use rotates about an axle 4 driven by a motor and gearbox unit 5. The bristles may be made from foam, such as that of automatic car wash brushes. The motor and gearbox 5 will be sized appropriately to drive the cleaning element in one or more directions as required by the operator and to rotate the cleaning element at a speed appropriate for the surface being cleaned. One or more pairs of support members or wheels 6, 7 are provided that support the cleaning apparatus against the surface being cleaned. One pair of wheels 6 are positioned proximate the corners of the lower side of the carriage and the other pair of wheels 7 are positioned proximate the corners of the upper side of the carriage. Preferably the wheels 6 and 7 are positioned on the carriage beyond the width of the cleaning element/brush 3. Preferably each wheel is mounted on a track 6a and 7a. Each track allows the position of each wheel to be adjusted in a forward and aft position relative to the cleaning element and surface being cleaned. This adjustability of the wheels allows the contact pressure of the bristles of cleaning element 3 against the surface to be varied. The adjustability of the position of each wheel may be automated when there are surface obstacles to be negotiated. This automated adjustability may be achieved using sensors similar to what is used in carwash systems. Alternatively, the adjustment could be made by an operator using a remote control. One or more suspension members or lifting tabs 8 are provided on the upper side of the carriage. On the lower side of the carriage are provided two or more castor wheels 9 to enable the cleaning apparatus 1 to be wheeled across a ground surface. Two pairs of electric ducted fan units 10 and 11 are positioned proximate each end of the axle 4 as best shown in FIG. 2. Each pair of fans together, in use, provide a thrust to the carriage of at least 5 kg, more preferably 8 kg, more preferably 10 kg in a forward direction towards the rotating brush. The overall weight of the apparatus is preferably around 100 kg. The electric ducted fan units are EDF JETFAN-120 eco Ejets+HET 800-68-830 fans, available from https://www.turbines-rc.com. These electric ducted fans provide significant stability to the cleaning apparatus and allow it to be operated and moved across the s structure or surface at relatively high speeds. In a preferred embodiment the fans use low voltage (between approximately 24-48 v) brushless DC motors. Corresponding rechargeable battery supplies 12 and 13 are also provided on the rear of the carriage 2, to provide a power supply to the fans, any winch that may be included on the apparatus and any electronics that may also be included, such as a warning lights or sounds. Shown in FIGS. 3, 4 and 6, is a further suspension member 14 positioned on the rear side of the cleaning apparatus. This suspension member 14 allows a strop or the like to be connected thereto to provide a three way suspension arrangement with lifting tabs 8. With reference to FIGS. 10 and 12, it can be seen that a three way strop system can be used to lift the cleaning apparatus. FIGS. 10 and 11 also show that a lightweight shroud 15 covers the carriage 2 and prevents the spraying of residual water, from the rear side of the cleaning apparatus away from the surface being cleaned. Preferably, the shrouding is made from a strong and light material, such as carbon fiber. As shown in FIGS. 6, 7, 8 and 9, the shrouding 15 has been removed to reveal the carriage framework 2 which supports the shrouding and the componentry of the cleaning apparatus. The framework 2 is also adapted and configured to provide strength and shape to the cleaning apparatus. It is to be appreciated that the framework 2 may be configured in a variety of ways to support the shrouding and componentry of the cleaning apparatus and that the embodiment illustrated is just one way of configuring the framework 2. The cleaning apparatus 1 is moved up and down relative to a building surface (not shown) by a portable winch mounted on the top of the building and connected to the cleaning apparatus through a line or cable (not shown) connected to the lifting tabs 8. The winch preferably is portable, self-reeling, has a long length of cable and has variable speed control. The winch may be positioned on a rooftop system, such as a rooftop rigging system that further controls movement along a direction relatively horizontal to the surface being cleaned. Alternatively, the winch could be supported on the cleaning apparatus such that the apparatus can winch itself up or down any surface.

Further, electronic installments could be made to allow remote adjustment or computer automated operation. One such installment is a location monitoring system which gives a remote operator or a building owner, statistics on the current location and progress, as a percentage, of the cleaning element in traversing a designated surface. It is to be appreciated that the rooftop system may be integrated into the building infrastructure or may be a moveable lifting or rigging frame installed for the cleaning job and the winch is mounted on site to the rooftop system available. In this way the rooftop system and winch can be used to control the up and down movement of the cleaning apparatus 1, while the rooftop system supports and controls the horizontal movement of the cleaning apparatus across the building surface.

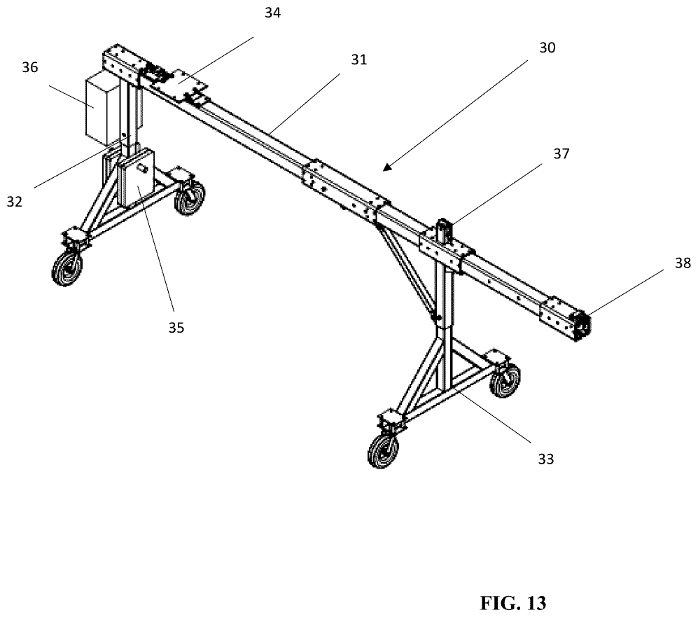

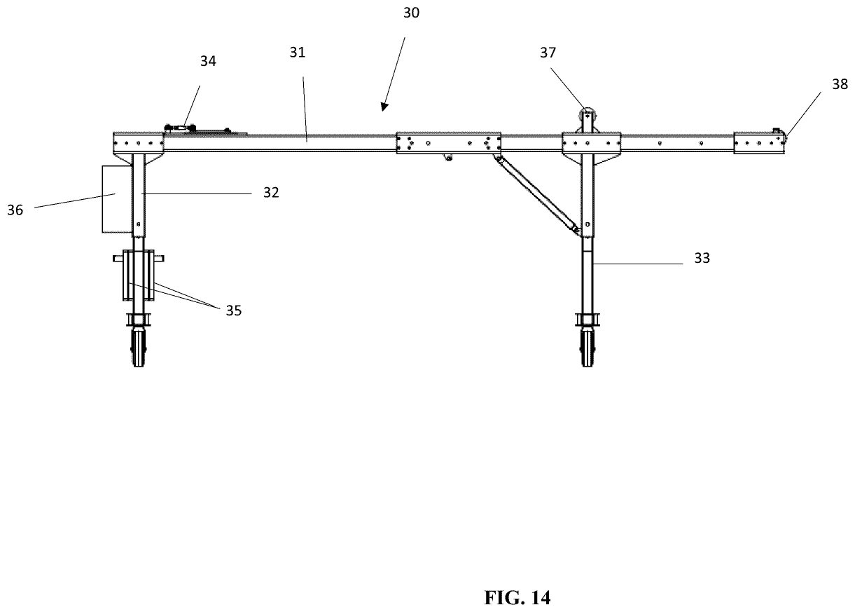

A mobile rigging system 30 suitable for use with a cleaning apparatus of the present invention is shown in FIGS. 13 and 14. A boom 31, is supported on a pair of wheeled frame members 32 and 33 proximate each end of the boom. The boom 31 includes a mounting plate 34 onto which a winch (not shown) may be mounted to winch a cleaning apparatus up and down the building by way of a winch cable, when in use. The frame member 32, which in use is most remote from the surface of the building being cleaned, includes a counterweight member 35, such as a series of counterweights, to provide some counterbalance to the weight of the cleaning apparatus. The frame member 32, also includes a power box 36 to power the winch. The frame member 33, which supports the end of the boom that is designed to extend over the side of the building also supports a pulley 37 through which the winch cable rides. The most remote end of the boom includes a further pulley 38 over which the winch cable bends as it drops down to the cleaning apparatus. Preferably, the mobile rigging system is modular and easy to assemble and deconstruct. More preferably the mobile rigging system has no components over 2 meters in length so the components can be transported to a rooftop setting using a building's existing lift system.

In use, it is entirely optional whether the cleaning element is rotated in a clockwise or anticlockwise manner. It may be preferable, for example that the cleaning element rotates in a clockwise direction, when observing from the left-hand side of the cleaning element, as the cleaning apparatus is winched up the surface being cleaned and in an anticlockwise direction as the cleaning apparatus descends the surface being cleaned. One of the benefits of the cleaning apparatus of this invention is that initial trials have shown a building surface can be cleaned as much as 50 percent quicker than other cleaning methods. This efficiency comes about because the cleaning apparatus is relatively lightweight (approximately 100 kgs) and is able to be moved quickly and effectively across the building system because of the thrust presented by the electric ducted fans. These fans provide significant stability to the cleaning apparatus and allow it to be operated and moved across the s structure or surface at relatively high speeds. In a preferred embodiment the fans use low voltage (between approximately 24-48 v) brushless DC motors. The fans provide sufficient thrust and improved stability by acting in a perpendicular direction toward the surface being cleaned. A significant benefit of this system is that the force required to keep the cleaning brush in contact with the surface being cleaned is self-contained on the cleaning apparatus and does not require lines extending to the ground surface to control and maintain the contact of the cleaning brush on the surface being cleaned.

The elements of the cleaning apparatus are constructed from materials on the basis of structural needs, considering such aspects as strength, weight reduction, durability and the like. Common structural materials such as metals, particularly, aluminium, stainless steel, polymeric materials, composites, ceramics and the like may be selected.

The cleaning apparatus described above ordinarily will require a fluid transport system, as most window washing is done with or in conjunction with the application of a fluid, particularly water. Spray wash systems, brush wash systems, roller applicator/scrub systems, fabric applicators, fabric strip applicators, and combinations thereof all use water to assist in surface soil removal and to minimize friction between any physical elements and surfaces being cleaned so as to reduce abrasion and scratching. The fluid may be water, treated water (e.g., demineralized, deionized, chemically treated) or other aqueous systems (with surfactants, ambiphilic materials to remain with the water but dissolve or soften hydrophobic and oleophilic materials) and other common cleaning fluids (ammonia, vinegar, etc.). In a preferred embodiment, a hose 16 (shown in FIGS. 10, 11 and 12) would be connected to the carriage to apply water through a series of spaced apart spray heads or nozzles 40 best shown in FIGS. 1, 2 and 11 located along the upper frame of the carriage above the cleaning element, which nozzles or spray heads spray water onto the rotating brush and surface being cleaned. The hose is connected to the cleaning apparatus by a quick release (push on and lock) connection although other connections such as a threaded hose connection are also envisaged. The hose can be connected from the ground and a pump (electric or fuel) used to pump the water up, or the hose could be connected from the top of the structure being cleaned. Alternatively, a water compressor or water blaster could be used push water through the nozzles or spray heads of the cleaning apparatus. It is to be appreciated that there are many ways of applying a liquid against the surfaces to be cleaned. The applicator may be a spray device, jet spray, fountain spray, roller brush(es), fabric sheets with reciprocating movement, water and air jets, squeegee system and the like, as well understood in the art. It is preferable that the liquid can be applied adequately without a significant pressure system being required.

During experimental trials of the cleaning apparatus, the user has found it easy to set up the cleaning apparatus, easy to deploy the apparatus for cleaning an upright surface, and comparatively quick and easy to clean an exterior building surface, saving many man hours in setting up systems and cleaning a building. The reduction of man hours means that buildings can be cleaned more cost effectively than with traditional systems. Furthermore, the user has found the cleaning apparatus as to be particularly stable even in high winds (15-25 knots). In high winds, window cleaning would usually not occur. The benefits of this electric ducted fan stabilising system is that a heavy counterweight system or lines that run from the ground to the carriage are not required to keep the cleaning apparatus against the surface to be cleaned. The lightweight nature of the cleaning apparatus also means that is easy to deploy from a verandah or a canopy roof without requiring expensive scaffolding or extra personnel.

A cleaning system as described herein may be used to provide a cleaning system for the cleaning of relatively flat surfaces, such as the exterior vertical surfaces of office buildings, hotels, hospitals without the need to suspend personnel from the building.

The surfaces being cleaned are generally particularly designed for glass or coated glass (e.g., surfaces having abrasion-resistant coatings, light filtering coatings, enhanced cleanable surfaces, etc.) surfaces, but any structure having a relatively flat surface may be suitably cleaned. The actual cleaning is done by the application of a cleaning liquid to the surface with sufficient forces applied from the cleaning element or bristles to assist in removal of dirt, film, particles, soil age, caked material, deposits, and the like from the surface. Although glass is a primary surface to be cleaned, any surface material, such as concrete, mortar, brick, stone, metals, wood, composites and the like may also be cleaned. The jet spray may be particularly desirable with more porous or absorbing surfaces. A preferred application system comprises brush application, sponge application, strip application, foam finger application, sheet application and the like, where physical elements exert a physical force such as a rubbing action against the surface to be cleaned in the presence of a cleaning liquid (which may be water, alone).

It is to be appreciated that a cleaning system, comprising a cleaning apparatus as described above, a winch and any power cable and hoses can be readily transported to and from a number of buildings. This cleaning system provides a portable building cleaning system that can be readily used on a number of buildings without the need to suspend an operator from the building structure. The cleaning system described therefore provides significant health and safety benefits over any cleaning system that requires an operator to be suspended from the building.

In another aspect, the invention provides a separate moveable and portable cleaning apparatus that enables the cleaning of relatively flat surfaces, and especially elevated and/or sloped and/or vertical surfaces without the use of elevated or suspended personnel at the specific site of cleaning.

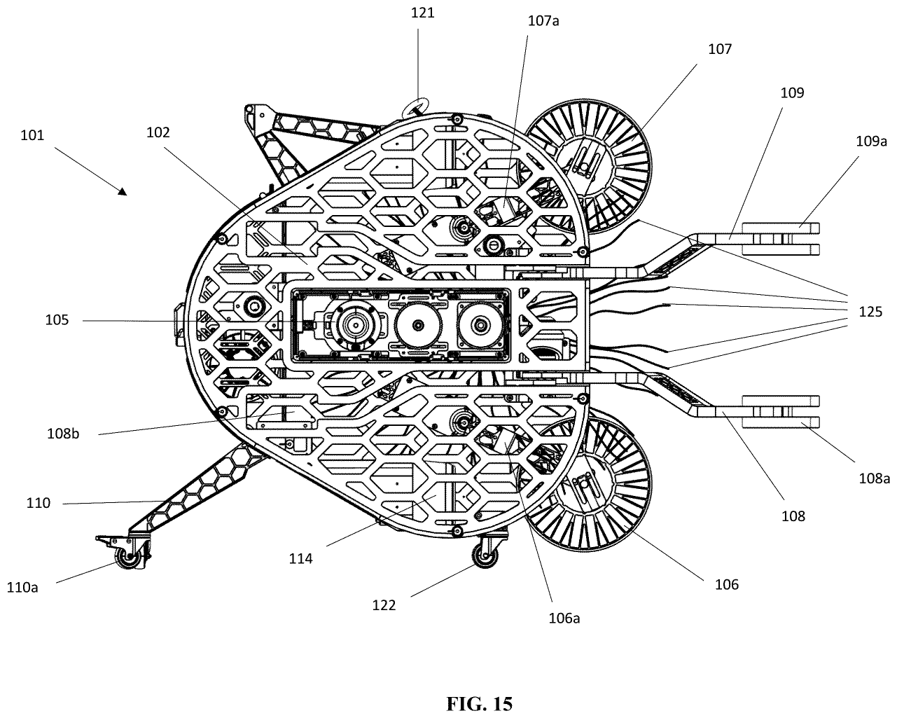

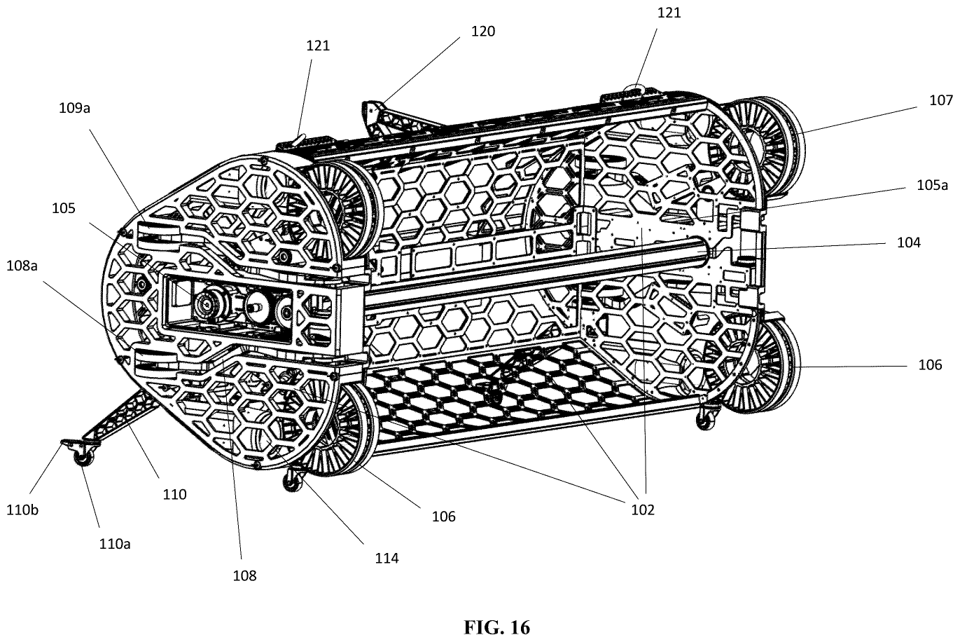

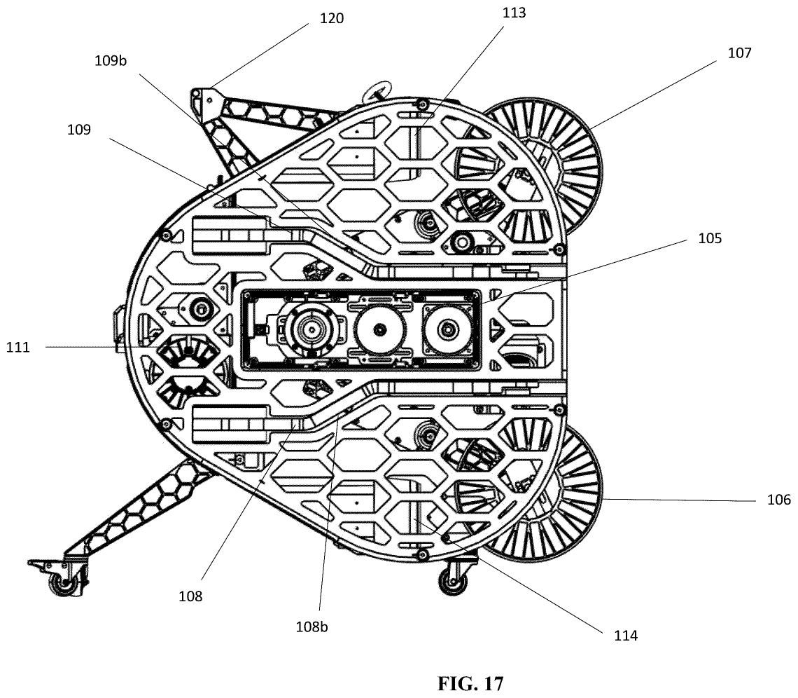

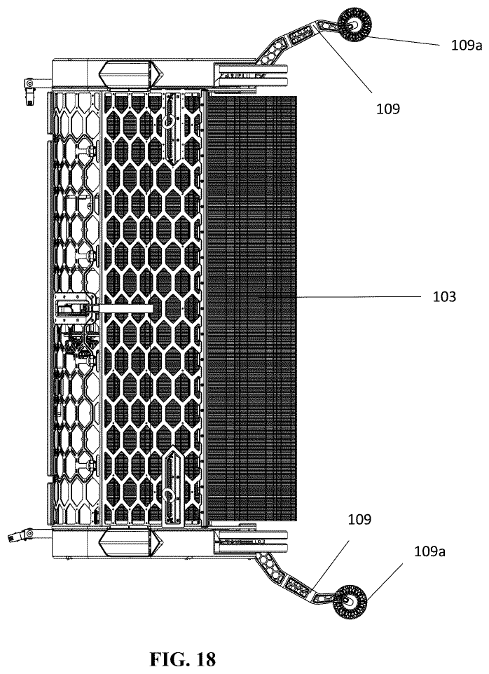

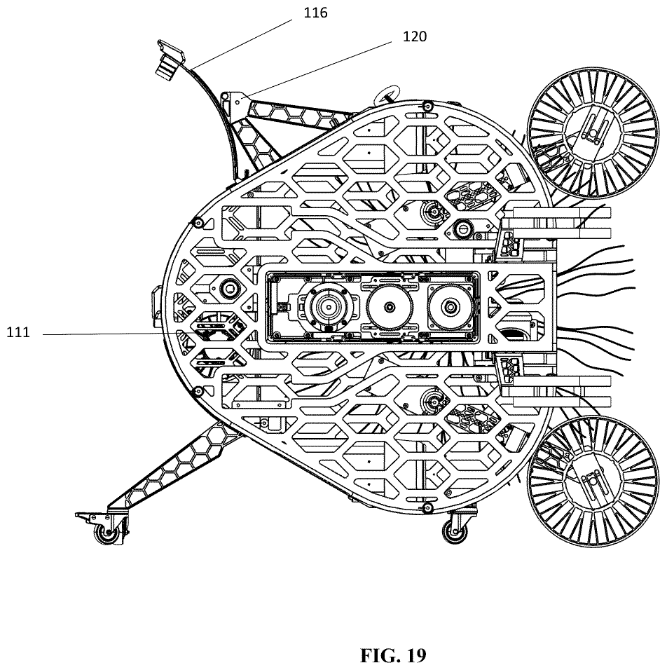

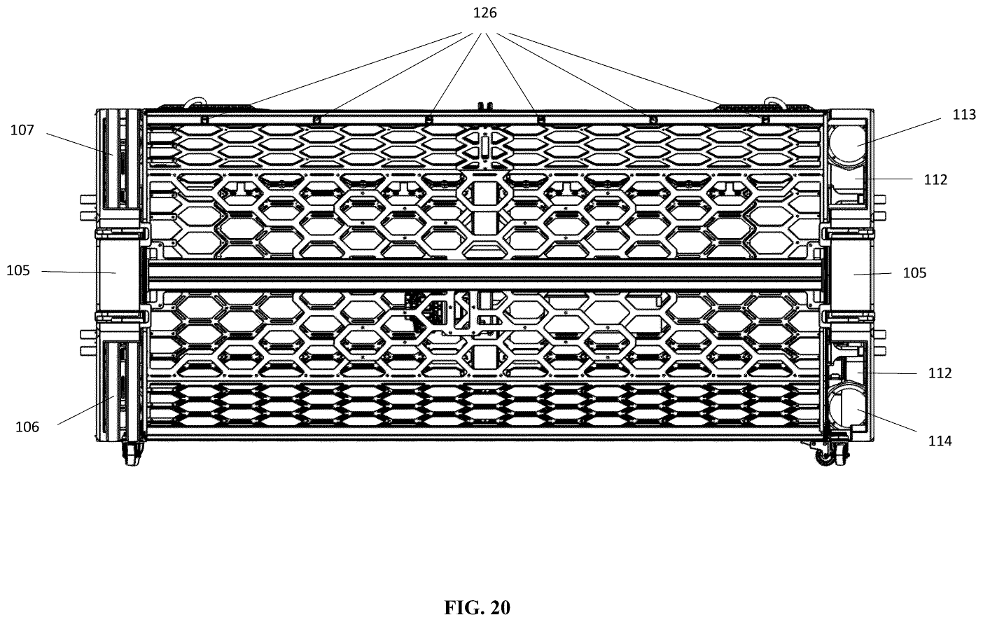

With reference to FIGS. 15 to 21, a second embodiment of a cleaning apparatus 101 is depicted. The cleaning apparatus comprises a carriage or framework 102 (preferably, a skeleton framework to minimize the weight of the apparatus) carrying at least a cleaning element 103 which may consist of a number of members having outer end portions that contact a surface area for cleaning or “bristles” or flexible brushing members 125, which cleaning element in use rotates about an axle 104 driven by at least one motor or gearbox unit 105. In the embodiment shown in FIG. 20, the apparatus includes two motor or gearbox units 105, 105a. In the embodiment shown, the motor gearbox units 105, 105a are located proximate each end of the axle 104. The motor or gearbox units may be protected by a cover (not shown). The bristles 125 may be made from foam, such as that of automatic car wash brushes. The motor gearbox will be sized appropriately to drive the cleaning element in one or more directions as required by the operator and to rotate the cleaning element at a speed appropriate for the surface being cleaned. It is to be appreciated that the axle 104 may be driven by one or more motors or gearbox units, and that the embodiment illustrated is just one way of driving the axle 104. One or more pairs of support members or wheels 106, 107 are provided that support the cleaning apparatus against the surface being cleaned. One pair of wheels 106 are positioned proximate the corners of the lower side of the carriage and the other pair of wheels 107 are positioned proximate the corners of the upper side of the carriage. Preferably the wheels 106, 107 are positioned on the carriage beyond the width of the cleaning element/brush. Preferably, each wheel 106, 107 is mounted on a track 106a, 107a. Each track may allow the position of the wheel to be adjusted in a forward and aft position relative to the cleaning element and surface being cleaned. This adjustability of the wheels allows the contact pressure of the bristles 125 of cleaning element against the surface to be varied. The adjustability of the position of each wheel may be automated when there are surface obstacles to be negotiated. This automated adjustability may be achieved using sensors similar to what is used in carwash systems. Alternatively, the adjustment could be made by an operator using a remote control. Preferably, the wheels 106, 107 are each mounted within a partial cavity 112 (as shown in FIG. 19), wherein each partial cavity 112 is of a complementary shape to the wheels. On the lower side of the carriage are provided two or more castor wheels 110a, 122 to enable the cleaning apparatus 101 to be wheeled across a ground surface. The caster wheels 110a may be directly attached to the apparatus 101 or may be attached to the apparatus via legs 110. The caster wheels may include a manually activated braking mechanism 110b. One or more pairs of lateral members 108, 109 are provided. The lateral members are mounted to the carriage at each end. The lateral members may be mounted to the carriage within a complementary cavity 108b, 109b. Preferably, each lateral member include a pivoting arm that extends outwardly from the carriage. In the embodiment shown, each pivoting arm at its distal end includes an auxiliary movement member 108a, 109a. Each auxiliary movement member may be a roller member, such as a wheel as shown in FIG. 19.

The apparatus may further include an actuator (such as a rotational actuator) (not shown) for selectively adjusting the positioning of the lateral members relative to the cleaning element and the surface being cleaned. The adjustability of the position of each lateral member by the actuator may be automated when there are surface obstacles to be negotiated, such as window frames or window ledges. For example, the lateral members may extend beyond an obstacle such as a window frame, and as the lateral members extend beyond the obstacle push the cleaning apparatus away from the surface to be cleaned. The arms may continue to extend outward such as to enable the machine to roll across the surface or until the apparatus has navigated its way around the obstacle. The adjustability of the position of each lateral member by the actuator may be automated using sensors similar to what is used in carwash systems. Alternatively, the actuator could be controlled by an operator using a remote control or a push button. In one embodiment, the actuator may control the positioning of the left-side lateral members independently of the right-side lateral members, or vice versa. It is to be appreciated that there are a plurality of intermediate positions of the lateral members between fully extended outwardly from the carriage and retracted inwardly towards the complementary cavity in which the lateral members may be housed.

This embodiment may further comprise two pairs of electric ducted fan units 113, 114 that are positioned about each end of the axle 104. Each pair of fans together, in use, provide a thrust to the carriage of at least 5 kg, more preferably 8 kg, more preferably 10 kg in a forward direction towards the rotating brush. The overall weight of the apparatus is preferably around 100 kg. The electric ducted fan units are EDF JETFAN-120 eco Ejets+HET 800-68-830 fans, available from https://www.turbines-rc.com. These electric ducted fans provide significant stability to the cleaning apparatus and allow it to be operated and moved across the s structure or surface at relatively high speeds. In a preferred embodiment the fans use low voltage (between approximately 24-48 v) brushless DC motors.

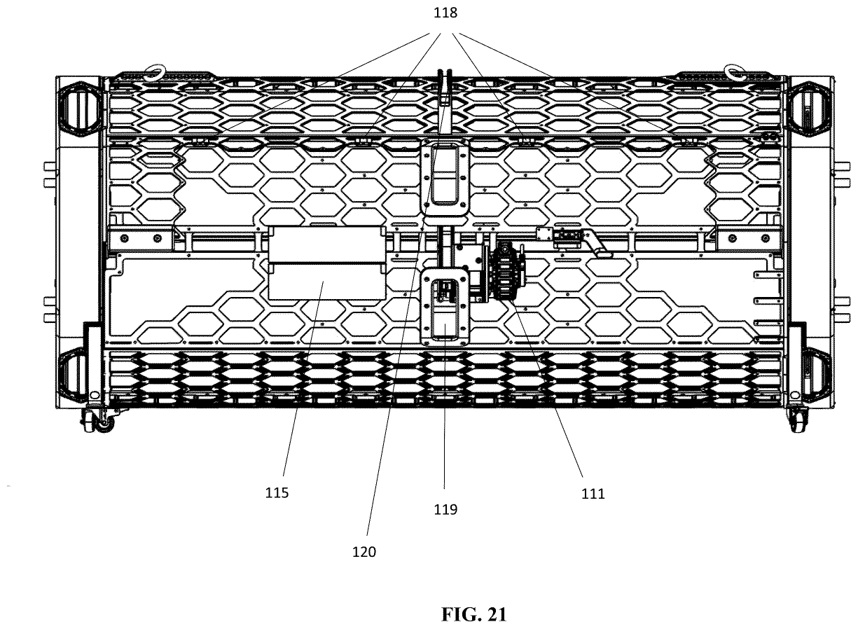

In use, the apparatus may be moved up and down relative to a building surface (not shown) by a winch 111 mounted to the cleaning apparatus. The winch 111 in this embodiment is supported or mounted to the cleaning apparatus such that the apparatus can winch itself up and down any surface. In this embodiment, the cleaning apparatus also includes a power box 115 (as shown in FIG. 21) that independently powers the winch.

The winch, preferably is self-reeling, has a long length of rope or cable and has variable speed control. The winch may connect to a support system, preferably a rooftop support system (not shown). It is to be appreciated that the rooftop system may be integrated into the building infrastructure or may be a moveable lifting or rigging frame installed for the cleaning job. In this way, the winch system can be used to control and support the upwards and downwards and lateral movement of the cleaning apparatus 101 across the surface to be cleaned.

In this embodiment, the winch 111 is mounted on the carriage or skeleton 102 proximate to the rear of the cleaning apparatus. It is to be appreciated that the winch may be mounted elsewhere on the cleaning apparatus. A pulley 120 is mounted on the skeleton 102. A suspension member, such as a rope, (not shown) may extend from the winch 111 through the pulley 120 to the rooftop, in use. The winch 111 is accessible through an access port 116. The access port 116 is hinged by way of a plurality of hinges 118 to enable its opening and closing. The access port 116 opens upwardly towards the pulley and closes downwardly away from the pulley. The access port 116, includes an opening 119 to allow the pulley 120 to protrude through the access port when the access port is in an opening position. The cleaning apparatus 101 may include lifting tabs 121 to which support members, such as cables or ropes from a mobile rigging system can attach (not shown).

The cleaning apparatus described above ordinarily will require a fluid transport system, as most window washing is done with or in conjunction with the application of a fluid, particularly water. Spray wash systems, brush wash systems, roller applicator/scrub systems, fabric applicators, fabric strip applicators, and combinations thereof all use water to assist in surface soil removal and to minimize friction between any physical elements and surfaces being cleaned so as to reduce abrasion and scratching. The fluid may be water, treated water (e.g., demineralized, deionized, chemically treated) or other aqueous systems (with surfactants, ambiphilic materials to remain with the water but dissolve or soften hydrophobic and oleophilic materials) and other common cleaning fluids (ammonia, vinegar, etc.). In a preferred embodiment, a hose (not shown) would be connected to the carriage to apply water through a series of spaced apart spray heads or nozzles 126 best shown in FIG. 20 located along the upper frame of the carriage above the cleaning element, which nozzles or spray heads spray water onto the rotating brush and surface being cleaned. The hose would be connected to the cleaning apparatus by a quick release (push on and lock) connection although other connections such as a threaded hose connection are also envisaged. The hose can be connected from the ground and a pump (electric or fuel) used to pump the water up, or the hose could be connected from the top of the structure being cleaned. Alternatively, a water compressor or water blaster could be used push water through the nozzles or spray heads of the cleaning apparatus. It is to be appreciated that there are many ways of applying a liquid against the surfaces to be cleaned. The applicator may be a spray device, jet spray, fountain spray, roller brush(es), fabric sheets with reciprocating movement, water and air jets, squeegee system and the like, as well understood in the art. It is preferable that the liquid can be applied adequately without a significant pressure system being required.

The carriage or skeleton 102 is also adapted and configured to provide strength and shape to the cleaning apparatus. Preferably, the skeleton is configured in a honey-comb lattice to minimise weight. It is to be appreciated that the carriage 102 may be configured in a variety of ways to support the skeleton and componentry of the cleaning apparatus and that the embodiment illustrated is just one way of configuring the skeleton 102.

The present invention and its embodiments have been described in detail. However, the scope of the present invention is not intended to be limited to the particular embodiments of the invention described in the specification. Various modifications, substitutions, and variations can be made to the disclosed material without departing from the spirit and/or essential characteristics of the present invention. Accordingly, one of ordinary skill in the art will readily appreciate from the disclosure that later modifications, substitutions, and/or variations performing substantially the same function or achieving substantially the same result as embodiments described herein may be utilized according to such related embodiments of the present invention. Thus, the following claims are intended to encompass within their scope modifications, substitutions, and variations to the embodiments of the invention disclosed herein.

1. An unmanned cleaning apparatus suitable for cleaning a surface of a structure comprising:
a carriage adapted to be moved in upward and downward directions relative to the surface of a structure,
a cleaning element rotatably mounted on the carriage that in use rotates about a substantially horizontal axis, the cleaning element being configured to contact the surface,
at least a pair of support members mounted on the carriage to support the apparatus against the surface,
at least a pair of electric ducted fans, with one fan of each pair positioned at each end of the carriage and together the pair of fans provide thrust to the carriage in a direction toward the surface being cleaned to stabilize the apparatus against the surface being cleaned when in use;
a motor that in use is operable remotely to rotate the cleaning element about its horizontal axis across the surface being cleaned; and
a spray boom that is mounted on the carriage providing a plurality of spaced apart nozzles that in use spray water towards the cleaning element and the surface of the structure being cleaned.

2. The apparatus as claimed in claim 1, further including at least one suspension member positioned proximate the top side of the carriage, which suspension member in use is connected to a winch line, which line, in use connects the apparatus to a winch that moves the carriage in an upward or downward direction as required.

3. The apparatus as claimed in claim 1, wherein the support member is a pair of wheels mounted on the carriage.

4. The apparatus as claimed in claim 3, wherein two pairs of wheels provide the support members.

5. The apparatus as claimed in claim 3 wherein the support member is two pairs of wheels, each wheel being mounted proximate each corner of the carriage.

6. The apparatus as claimed in claim 1, wherein each fan at each end of the carriage is in a spaced apart arrangement about the horizontal axis of the cleaning element.

7. The apparatus as claimed in claim 6, wherein the electric ducted fans are battery powered and operable independently of any external power source.

8. The apparatus as claimed in claim 1 wherein the pair of electric ducted fans provide a combined thrust of at least 5% the weight of the cleaning apparatus.

9. (canceled)

10. The apparatus as claimed in claim 1, wherein the cleaning element is a rotatable brush.

11. (canceled)

12. A cleaning system comprising a cleaning apparatus as claimed in claim 1 and a portable winching member that in use is configured to winch the cleaning apparatus up and down a surface being cleaned, the winch member in use being positioned on a surface above the surface being cleaned by the cleaning apparatus.

13. The cleaning system as claimed in claim 12, wherein the portable winching member is connected to roof rigging or a roof mounted lifting device above the surface being cleaned by the cleaning apparatus.

14. The cleaning system as claimed in claim 12, wherein the cleaning apparatus further includes a portable winching member that in use is configured to winch the cleaning apparatus up and down a surface being cleaned, the winch member in use being positioned on a surface above the surface being cleaned by the cleaning apparatus.

15. An unmanned cleaning apparatus suitable for cleaning a surface of a structure comprising:
a carriage adapted to be moved in upward and downward directions relative to the surface of a structure,
a cleaning element rotatably mounted on the carriage that in use rotates about a substantially horizontal axis, the cleaning element being configured to contact the surface, at least a pair of support members mounted on the carriage to support the apparatus against the surface,
at least a pair of lateral members configured and adapted to support the movement of the carriage across the structure surface when in use,
a motor that in use is operable remotely to rotate the cleaning element about its horizontal axis across the surface being cleaned; and
a spray boom that is mounted on the carriage providing a plurality of spaced apart spray nozzles that in use spray water towards the cleaning element and the surface of the structure being cleaned.

16. The apparatus of claim 15, wherein each lateral member comprises a pivoting arm that extends outwardly from the carriage.

17. The apparatus of claim 16, wherein each arm at its distal end includes an auxiliary movement member.

18. The apparatus of claim 15, wherein the apparatus comprises at least two pairs of lateral members.

19. The apparatus of claim 15, wherein the apparatus further comprises at least a pair of electric ducted fans, with one fan of each pair positioned at each end of the carriage and together the pair of fans provide thrust to the carriage in a direction toward the surface being cleaned to stabilize the apparatus against the surface being cleaned when in use.

20. The apparatus of claim 19, wherein two pairs of electric ducted fans are provided with one fan of each pair positioned at each end of the carriage, each fan at each end of the carriage being in a spaced apart arrangement about the horizontal axis of the cleaning element.

21. The apparatus of claim 19, wherein the electric ducted fans are battery powered and operable independently of any external power source.

22. The apparatus of any one of claims 19 to 21, wherein the pair of electric ducted fans provide a combined thrust of at least 5% the weight of the cleaning apparatus.

23. (canceled)

24. (canceled)

25. (canceled)

26. (canceled)

27. (canceled)

28. (canceled)
